(19) United States
(12) Patent Application Publication
(10) Pub. No.: US 2017/0260659 A1
(43) Pub. Date: Sep. 14, 2017

(54) METHOD FOR MANUFACTURING A FIBROUS STRUCTURE

(71) Applicant: SAFRAN CERAMICS, Le Haillan (FR)

(72) Inventors: Sylvie LOISON, Saint-medard (FR); Hervé EVRARD, Le Haillan (FR); Marc MONTAUDON, Bordeaux (FR)

(21) Appl. No.: 15/510,503

(22) PCT Filed: Sep. 10, 2015
(86) PCT No.: PCT/FR2015/052410

§ 371 Date: Mar. 10, 2017

(30) Foreign Application Priority Data
Sep. 12, 2014 (FR) 1458581

(51) Int. Cl. D02J 1/02; D04H 1/46; D01F 9/08; D04H 18/02

(52) U.S. Cl. CPC D02J 1/02; D04H 18/02; D04H 1/46; C01B 31/36; D01F 9/08

(57) ABSTRACT

A method of fabricating a fiber structure, the method including a) forming at least one essentially amorphous ceramic fiber by applying heat treatment at a temperature lying in the range 900° C. to 1200° C. to at least one fiber that is a precursor of ceramic fiber; and b) performing one or more textile operations using at least one essentially amorphous ceramic fiber formed by performing step a) in order to form a fiber structure including the at least one essentially amorphous ceramic fiber.

### BACKGROUND OF THE INVENTION

The invention relates to methods of fabricating fiber structures and fiber preforms, the method including a step of applying heat treatment to at least one fiber that is a ceramic fiber precursor.

FR 2 637 586 describes making woven and needled fabric from fully cross-linked organosilicate precursor fibers. In that document, fibers that are precursors of ceramic fibers are subjected to moderate heat treatment (i.e. to a temperature lying in the range 250° C. to 550° C.) in order to cross-link them completely while conserving them in the organic state. It is specified that the temperature of 550° C. should not be exceeded in the heat treatment in order to avoid degrading the elongation at break of the fibers. One or more textile operations are then carried out on those fibers as treated in that way. FR 2 637 586 teaches that the fibers obtained after the moderate heat treatment present both traction strength and elongation at break that are sufficient to be subjected to textile operations without being damaged. Once the fabric has been made, the precursor fibers are pyrolyzed in order to obtain an SiC fabric.

Nevertheless, tests carried out by the inventors for needling precursor fibers treated in accordance with FR 2 637 586 have given results that are not completely satisfactory. Without seeking to be tied to any particular theory, the inventors are of the opinion that traction strength and elongation at break are not the only parameters that are pertinent for enabling a fiber to be suitable for needling. Specifically, the inventors have observed that fibers treated in accordance with FR 2 637 586 do not present satisfactory compression strength, with the fibers breaking on contact with the needle.

There therefore exists a need to obtain novel methods of fabricating fiber structures in which the fibers are treated so as to be capable of appropriately withstanding the performance of one or more textile operations, and in particular the performance of needling, stitching, and/or weaving operations.

### OBJECT AND SUMMARY OF THE INVENTION

To this end, in a first aspect, the invention provides a method of fabricating a fiber structure, the method comprising the following steps:

a) forming at least one essentially amorphous ceramic fiber by applying heat treatment at a temperature lying in the range 900° C. to 1200° C. to at least one fiber that is a precursor of ceramic fiber; and

b) performing one or more textile operations using at least one essentially amorphous ceramic fiber formed by performing step a) in order to form a fiber structure including said at least one essentially amorphous ceramic fiber.

The term “essentially amorphous ceramic fiber” should be understood as meaning that at least 90%, e.g. at least 95%, e.g. all, of the weight of said ceramic fiber is in the amorphous state. In particular, it is possible for no crystalline structure to be detected by X-ray diffraction in a ceramic fiber that is essentially amorphous.

By performing step a), the invention advantageously makes it possible to impart satisfactory mechanical properties to the treated fibers enabling them to avoid being damaged while textile operations are being performed, such as weaving, stitching, or needling operations. The heat treatment of step a) is performed in a range of temperatures that is sufficiently low to avoid significantly crystallizing the ceramic fiber and to conserve a structure that is essentially amorphous. The inventors have observed that a ceramic fiber presenting a material state as obtained after step a) presents improved ability to withstand the performance of textile operations.

Specifically, step a) makes it possible to obtain fibers having sufficient stiffness, in particular to present good compression strength, while being sufficiently flexible to be capable of being appropriately deformed during the textile operation(s) that is/are performed.

In an implementation, the ceramic fiber precursor fiber(s) may be subjected during all or part of step a) to a temperature lying in the range 900° C. to 1000° C. In a variant, the ceramic fiber precursor fiber(s) may be subjected during all or part of step a) to a temperature lying in the range 1000° C. to 1100° C. Also in a variant, the ceramic fiber precursor fiber(s) may be subjected during all or part of step a) to a temperature lying in the range 1100° C. to 1200° C.

In an implementation, a plurality of fibers that are precursors of ceramic fibers may be treated during step a).

In an implementation, one or more essentially amorphous SiC fibers may be formed during step a).

The essentially amorphous ceramic fiber(s) formed during step a) may present a Young's modulus that is less than or equal to 200 gigapascals (GPa).

Step b) may include performing at least one textile operation selected from the following operations: stretch-breaking at least one fiber, carding fibers, lapping fiber fabrics, bonding fiber fabrics together by needling, bonding fiber fabrics together by stitching, weaving fibers, knitting fibers, and braiding fibers.

The weaving of the fibers may be two-dimensional weaving or three-dimensional weaving.

In an implementation, during step b) a plurality of superposed fiber fabrics may be bonded together by needling, at least one of the fiber fabrics including essentially amorphous ceramic fibers formed by performing step a).

Using a needled fiber structure as a replacement for multilayer woven structure advantageously makes it possible to obtain a regular array of pores facilitating the insertion of various types of matrix, in particular when the matrix is formed by infiltration in the molten state.

The fiber fabrics bonded together by needling may be 2D fabrics.

In particular, at least one of the needled fiber fabrics may comprise a mixture of essentially amorphous ceramic fibers formed by performing step a) and fibers other than said essentially amorphous ceramic fibers. The fibers other than said essentially amorphous ceramic fibers may be carbon fibers and/or ceramic fibers.

In a variant, at least one of the needled fiber fabrics includes only essentially amorphous ceramic fibers formed by performing step a).

In an implementation, a first fiber fabric including essentially amorphous ceramic fibers formed by performing step a) may be bonded by needling to a second fiber fabric including crystalline ceramic fibers and/or carbon fibers.

Thus, in the context of the invention, it is possible to perform needling on a multilayer structure made up in part of crystalline ceramic fibers and in part of essentially amorphous ceramic fibers. The crystalline ceramic fibers are very rigid and thus not transferable, whereas the essentially amorphous ceramic fibers are transferable. Once the essentially amorphous ceramic fibers have been transferred, they are structured in situ so as to form crystalline ceramic fibers. Nevertheless, the breaking stresses of such crystalline ceramic fibers formed in situ can be lower than the breaking stresses of fibers that were already in crystalline form during needling.

Thus, the fact of performing needling on a multilayer structure comprising both crystalline ceramic fibers and essentially amorphous ceramic fibers is advantageous, since this makes it possible to obtain a needled fiber structure that presents breaking stress that is higher than that of a fiber structure obtained by needling ceramic fibers in amorphous form only.

In a variant, each of the fiber fabrics bonded by needling may include essentially amorphous ceramic fibers formed by performing step a).

In an implementation, step b) may include weaving a plurality of essentially amorphous ceramic fibers formed by performing step a).

The essentially amorphous ceramic fibers formed by performing step a) are more flexible and consequently more weavable than crystalline ceramic fibers. Weaving essentially amorphous ceramic fibers thus makes it possible to make a wider variety of fiber structures than weaving crystalline ceramic fibers.

In an implementation, step b) may include forming at least one stretch-broken fiber by stretching at least one essentially amorphous ceramic fiber formed by performing step a).

In an implementation, step b) may include stitching together a plurality of fiber fabrics usipg at least one stitching yarn formed by said at least one stretch-broken fiber.

In an implementation, step b) may include forming a plurality of stretch-broken fibers by stretching a plurality of essentially amorphous ceramic fibers formed by performing step a) and the stretch-broken fibers may be woven during step b).

The fibers obtained by stretch-breaking can give rise to yarns that are fine and can thus advantageously make it possible to weave fine portions of composite material parts, e.g. the leading edge of an airfoil.

The present invention also provides a method of fabricating a fiber preform, including the following step:

c) forming a fiber preform by subjecting the fiber structure obtained by performing a method as defined above to heat treatment for structuring the essentially amorphous ceramic fiber(s) present in the fiber structure in order to transform the essentially amorphous ceramic fiber(s) into crystalline ceramic fiber(s).

A temperature higher than 1200° C. may be imposed during the structuring heat treatment.

The present invention also provides a method of fabricating a ceramic matrix composite material part, the method including a step of forming a ceramic matrix in the pores of the fiber preform obtained by performing the method as described above.

In an implementation, the matrix may be formed by a method of infiltration in the molten state.

In particular, in composite material parts made in accordance with the invention, the volume fraction V_{f} corresponding to the volume occupied by the fibers may be relatively high, e.g. greater than or equal to 30%, or 35%, or 50%.

### BRIEF DESCRIPTION OF THE DRAWINGS

Other characteristics and advantages of the invention appear from the following description of particular implementations of the invention, given as non-limiting examples and with reference to the accompanying drawings, in which:

FIG. 1 is a block diagram of an implementation of the method of the invention;

FIGS. 2A, 2B, 3A, and 3B are photographs showing the results of needling tests obtained with fibers treated in accordance with step a); and

FIGS. 4A and 4B are photographs showing the result of a needling test obtained with fibers that were subjected to heat treatment different from that of step a).

### DETAILED DESCRIPTION OF IMPLEMENTATIONS

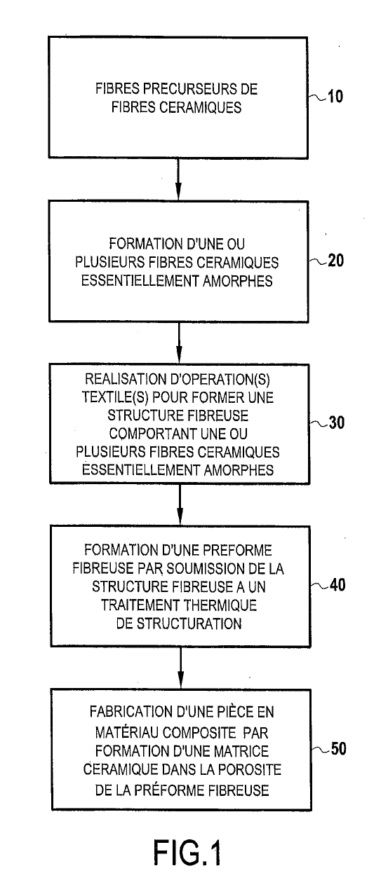

FIG. 1 shows a succession of steps in a method of the invention. The method begins with fibers that are precursors of ceramic fibers (step 10), e.g. fibers that are precursors of SiC fibers. By way of example, it is possible to use fiber precursors of the “Tyranno” type from the supplier UBE, or of the “Nicalon” type from the supplier NGS. These precursors are then spun using methods that are well known to the person skilled in the art.

In step 20, one or more essentially amorphous ceramic fibers are formed by applying heat treatment in accordance with step a). During step a), a temperature lying in the range 900° C. to 1200° C. may be imposed for a duration longer than or equal to 1 minute, e.g. longer than or equal to 10 minutes, e.g. lying in the range 10 minutes to 30 minutes. The temperature imposed during step 20 may not exceed 1200° C.

Thereafter, in step 30, one or more textile operations are performed in order to form a fiber structure.

By way of example, it is possible to begin by weaving a plurality of essentially amorphous ceramic fibers formed by performing step a) in order to obtain a first fiber fabric, and then to proceed with needling that first fiber fabric together with a second fiber fabric so as to form all or part of a fiber structure. Under such circumstances, the second fiber fabric may optionally include essentially amorphous ceramic fibers formed by performing step a).

In a variant, it is possible to begin by weaving a plurality of essentially amorphous ceramic fibers formed by performing step a) in order to obtain a first fiber fabric, and then to proceed with stitching this first fiber fabric to a second fiber fabric in order to form all or part of the fiber structure. Under such circumstances, the second fiber fabric may optionally include essentially amorphous ceramic fibers formed by performing step a).

In another variant, the fiber structure is obtained directly during step 30 by weaving fibers, the woven fibers including a plurality of essentially amorphous ceramic fibers formed by performing step a). Under such circumstances, it is possible for the fiber structure to comprise only ceramic fibers that are essentially amorphous and formed by performing step a). In a variant, the fiber structure may include a mixture of essentially amorphous ceramic fibers formed by performing step a) and carbon fibers and/or ceramic fibers other than said essentially amorphous ceramic fibers.

It is also possible during step 30 to carry out stretch-breaking of one or more essentially amorphous ceramic fibers formed by performing step a) in order to form one or more stretch-broken fibers. The stretch-broken fibers can then be used as stitching yarn for stitching together a plurality of fiber fabric in order to form all or part of the fiber structure. At least one of the stitched fiber fabrics may include essentially amorphous ceramic fibers formed by performing step a). The stretch-broken fibers may also be woven to form all or part of the fiber structure.

Other variants are possible, such as for example knitting or braiding a plurality of essentially amorphous ceramic fibers formed by performing step a) in order to form all or part of the fiber structure.

Once the fiber structure has been obtained, it is subjected to structuring heat treatment. The essentially amorphous ceramic fibers formed by performing step a) that are present in the fiber structure become transformed into crystalline ceramic fibers.

### EXAMPLE

Tests have been performed in order to evaluate the needleability of fibers obtained after carrying out various different heat treatments.

The needleability of three types of fiber was evaluated:

test 1: fibers obtained after applying heat treatment at 1000° C. to precursor fibers of the “Nicalon” type from the supplier NGS;

test 2: fibers obtained after applying heat treatment at 900° C. to precursor fibers of the “Tyranno” type from the supplier UBE; and

test 3: fibers obtained after applying heat treatment at 850° C. to precursor fibers of the “Tyranno” type from the supplier UBE.

The fibers were superposed while flat (without twisting) on a polypropylene felt having thickness of 11 millimeters (mm) and they were put under tension. A test of needling the fibers was then performed in order to evaluate whether or not the fibers are transferred as a result of contact with the needle. The needle that was used for the needling was a fork needle.

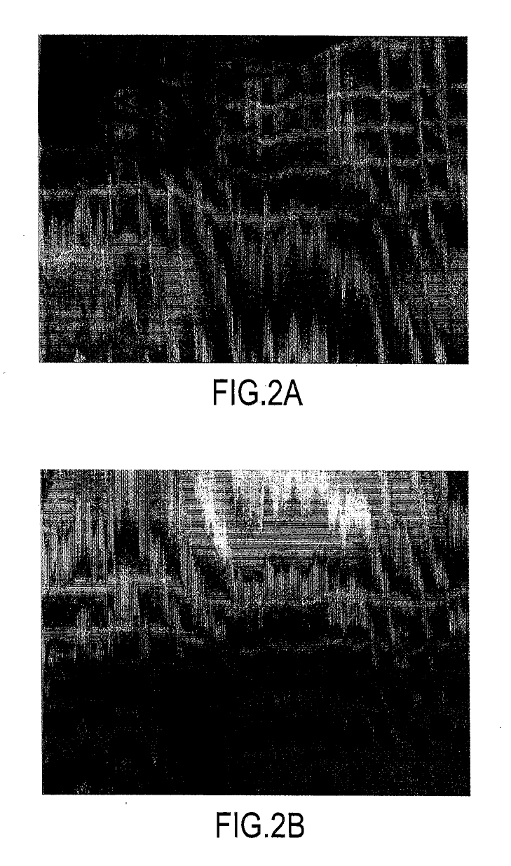

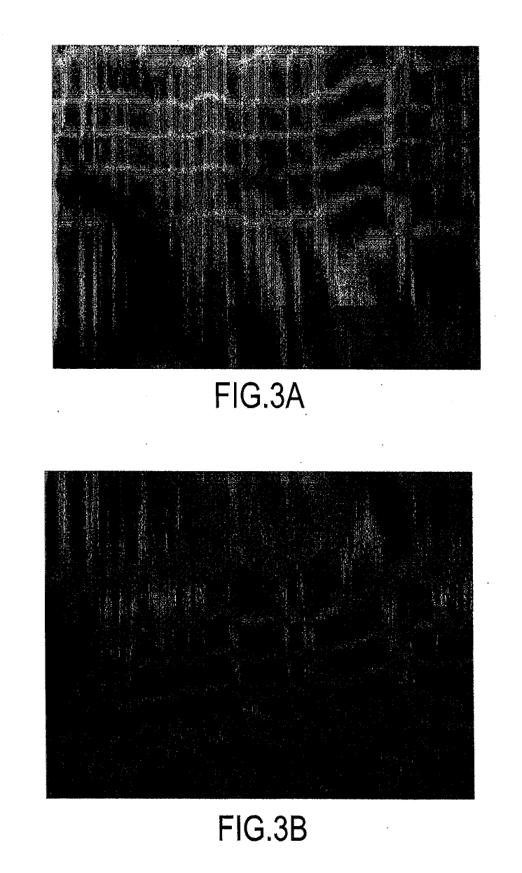

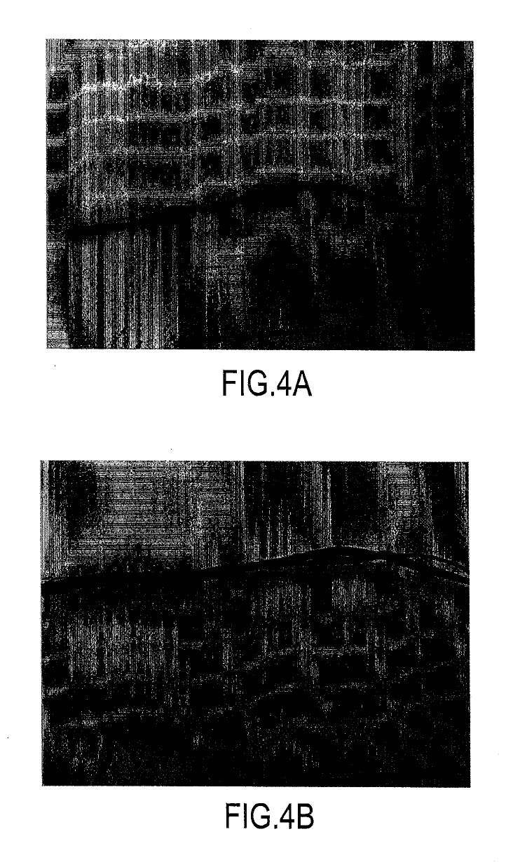

Photographs showing the results of test 1 are provided in FIGS. 2A and 2B, photographs showing the results of test 2 are provided in FIGS. 3A and 3B, and photographs showing the results of test 3 are provided in FIGS. 4A and 4B.

It can be seen that the fibers transferred correctly after needling for the heat treatments of tests 1 and 2 (see FIGS. 2A, 2B, 3A, and 3B).

After the heat treatment of test 3, the fibers were not capable of being needled correctly. During test 3, the fibers were damaged as a result of making contact with the needle and they were not transferred (see FIGS. 4A and 4B).

Other tests have been carried out in the same manner using the same type of needle. The results are given in Table 1 below. In Table 1, “OK” means that the tested fiber is suitable for needling, and “NOK” means that the tested fiber is not suitable for needling.

TABLE 1

| | Temperature of the heat treatment | | | | | |
|---|---|---|---|---|---|---|
| | 850° C. | 900° C. | 950° C. | 1000° C. | 1050° C. | 1100° C. |
| Sized Tyranno S | NOK | OK | OK | OK | | |
| diameter (μm) | 16.5 | 15 | 14.4 | 14.5 | | |
| breaking stress (MPa) | 490 | 1340 | 1550 | 1645 | | |
| Young's modulus (GPa) | 38 | 94 | 107 | 113 | | |
| Sized Tyranno S | | OK | OK | OK | NOK | |
| diameter (μm) | | 14.9 | 14.4 | 14.4 | 14.2 | |
| breaking stress (MPa) | | 1040 | 1775 | 1600 | 1870 | |
| Young's modulus (GPa) | | 58 | 114 | 131 | 106 | |
| Non-sized Nicalon | | | | OK | NOK | NOK |
| diameter (μm) | | | | 15.7 | 15.3 | 14.8 |
| breaking stress (MPa) | | | | 2995 | 1085 | 1375 |
| Young's modulus (GPa) | | | | 153 | 200 | 181 |

The terms “comprising/containing a” should be understood as “comprising/containing at least one”.

The term “lying in the range . . . to . . . ” should be understood as including the limits.

1. A method of fabricating a fiber structure, the method comprising the following steps:
a) forming at least one essentially amorphous ceramic fiber by applying heat treatment at a temperature lying in the range 900° C. to 1200° C. to at least one fiber that is a precursor of ceramic fiber; and
b) performing one or more textile operations using at the least one essentially amorphous ceramic fiber formed by performing step a) in order to form a fiber structure including said at least one essentially amorphous ceramic fiber.

2. A method according to claim 1, wherein during step b) a plurality of superposed fiber fabrics are bonded together by needling, at least one of the fiber fabrics including essentially amorphous ceramic fibers formed by performing step a).

3. A method according to claim 2, wherein a first fiber fabric including essentially amorphous ceramic fibers formed by performing step a) is bonded by needling to a second fiber fabric including crystalline ceramic fibers and/or carbon fibers.

4. A method according to claim 2, wherein each of the fiber fabrics bonded by needling includes essentially amorphous ceramic fibers formed by performing step a).

5. A method according to claim 1, wherein step b) includes weaving a plurality of essentially amorphous ceramic fibers formed by performing step a).

6. A method according to claim 1, wherein step b) includes forming at least one stretch-broken fiber by stretching the at least one essentially amorphous ceramic fiber formed by performing step a).

7. A method according to claim 6, wherein step b) includes stitching together a plurality of fiber fabrics using at least one stitching yarn formed by said at least one stretch-broken fiber.

8. A method according to claim 6, wherein step b) includes forming a plurality of stretch-broken fibers by stretching a plurality of essentially amorphous ceramic fibers formed by performing step a) and wherein the stretch-broken fibers are woven during step b).

9. A method according to claim 1, wherein a plurality of fibers that are precursors of ceramic fibers are treated during step a).

10. A method according to claim 1, wherein one or more essentially amorphous SiC fibers are formed during step a).

11. A method of fabricating a fiber preform, including the following step:
c) forming a fiber preform by subjecting a fiber structure obtained by performing a method according to claim 1 to heat treatment for structuring the essentially amorphous ceramic fiber(s) present in the fiber structure in order to transform the essentially amorphous ceramic fiber(s) into crystalline ceramic fiber(s).

12. A method of fabricating a ceramic matrix composite material part, the method including a step of forming a ceramic matrix in pores of the fiber preform obtained by performing the method of claim 11.
